(19) United States
(12) Patent Application Publication
(10) Pub. No.: US 2014/0236696 A1
(43) Pub. Date: Aug. 21, 2014

(54) SYSTEM AND METHOD FOR AUTOMATICALLY DETECTING AND REJECTING FRADULENT COUPONS

(71) Applicant: Meijer, Inc., (US)

(72) Inventors: Elmer L. Robinson, JR., Grand Rapids, MI (US); Gail E. VanNoller, Lowell, MI (US)

(21) Appl. No.: 13/772,953

(22) Filed: Feb. 21, 2013

(51) Int. Cl. G06Q 30/02

(52) U.S. Cl. CPC G06Q 30/0225
USPC 705/14.26

(57) ABSTRACT

A system for processing a coupon offered for redemption in relation to a purchase transaction may include a database having stored therein fraudulent coupon data corresponding to one or more fraudulent coupons, and a purchase interface to process the purchase transaction. The purchase interface illustratively has a coupon processing module to compare the coupon to the fraudulent coupon data stored in the database and to automatically deduct a discount amount of the coupon from a price of a corresponding item included in the purchase transaction if the coupon does not match any of the one or more fraudulent coupons.

### BACKGROUND

Retailers of goods and services may typically offer such goods and services for purchase via one or more conventional brick-and-mortar retail outlets. Such retail outlets may include any number of point-of-sale systems via which customers purchase items selected while shopping according to a so-called “checkout” process. Retailers may additionally or alternatively operate one or more on-line services via which customers may purchase items.

Retailers may further allow customers to present one or more discount coupons, e.g., in the form of print media coupons, virtual print media coupons and/or virtual coupons, during a purchase transaction for redemption against one or more items included in the purchase transaction. All such discount coupons provide an economic benefit to customers who shop with such retailers, and retailers in turn have an interest in ensuring that any such discount coupons redeemed by the retailer are authentic, i.e., genuine and not fraudulent.

### SUMMARY

The present invention may comprise one or more of the features recited in the attached claims, and/or one or more of the following features and combinations thereof. A system for processing a coupon offered for redemption in relation to a purchase transaction may illustratively comprise a database having stored therein fraudulent coupon data corresponding to one or more fraudulent coupons, and a purchase interface to process the purchase transaction, the purchase interface having a coupon processing module to compare the coupon to the fraudulent coupon data stored in the database and to automatically deduct a discount amount of the coupon from a price of a corresponding item included in the purchase transaction if the coupon does not match any of the one or more fraudulent coupons.

A method for processing a coupon offered for redemption in relation to a purchase transaction may illustratively comprise comparing the coupon to fraudulent coupons stored in a fraudulent coupon database, and automatically deducting a discount amount of the coupon from a price of a corresponding item included in the purchase transaction if the coupon does not match a fraudulent coupon in the fraudulent coupon database.

### BRIEF DESCRIPTION OF THE DRAWINGS

FIG. 1 is a simplified block diagram of an embodiment of a system in which customers at a retail enterprise may redeem coupons, and which system is configured to automatically detect and reject fraudulent coupons.

FIG. 2 is a simplified block diagram of an embodiment of one of the point-of-sale systems illustrated in FIG. 1.

FIG. 3 is a simplified block diagram of an embodiment of an environment of the main server of FIG. 1.

FIG. 4 is a simplified block diagram of an embodiment of an environment of one of the point-of-sale systems illustrated in FIGS. 1 and 2.

FIG. 5 is a simplified flow diagram of an embodiment of a process for acquiring fraudulent coupon information and providing corresponding fraudulent coupon data files to one or more of the local hub servers illustrated in FIG. 1.

FIG. 6 is a simplified flow diagram of an embodiment of a process carried out by one or more of the point-of-sale systems illustrated in FIGS. 1 and 4 for processing customer-presented coupons.

FIG. 7 is a simplified flow diagram of an embodiment of a coupon processing routine that is part of the process illustrated in FIG. 6.

FIG. 8 is a simplified block diagram of an embodiment in which one or more user computing devices may be used to convert one or more print media coupons to virtual print media coupons for redemption at one of the point-of-sale systems illustrated in FIG. 1 at which a customer is purchasing one or more corresponding items.

FIG. 9 is a simplified block diagram of an embodiment of one of the user computing devices illustrated in FIG. 8.

FIG. 10 is a simplified block diagram of an embodiment of an environment of the user computing device of FIG. 9.

FIG. 11 is a simplified block diagram illustrating one of the user computing devices of FIGS. 8-10 displaying a virtual print media coupon, converted from a print media coupon, for scanning by one of the point-of-sale systems of FIG. 1 at which a customer is purchasing a corresponding item.

FIG. 12 is a simplified block diagram of an embodiment of a virtual customer coupon repository within the server database of the main server, as viewed on a display monitor of one of the user computing devices of FIG. 9, showing an example storage and display of virtual print media coupons captured and stored within the server database by one of the user computing devices.

FIG. 13 is a simplified block diagram of an alternate embodiment of an environment of the main server of FIG. 1.

FIG. 14 is a simplified flow diagram of a process which may be carried out by the main server of FIGS. 1, 3 and 13 for rejecting fraudulent virtual print media coupons which a customer may attempt to add to the customer's virtual customer coupon repository illustrated in FIG. 12.

FIG. 15 is a simplified flow diagram of a process which may be carried out by the main server of FIGS. 1, 3 and 13 for deleting or disabling virtual print media coupons which a customer has added to the customer's virtual customer coupon repository illustrated in FIG. 12.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

The terms “customer,” “shopper” and “user,” and variants thereof, are used interchangeably in the following description, and such terms should be understood to refer interchangeably to an individual or a predefined group of individuals, e.g., members of a family, employees of a common business entity, etc., who shops at and purchases items from a retail enterprise.

The term “virtual coupon” (and/or “virtual customer coupon”) is defined for purposes of this disclosure as a discount coupon stored in a memory device in the form of data, information and/or instructions which may be accessed from, re-stored in and/or deleted from a memory by a processor, and which may be manipulated and/or processed by a processor to determine information relating to one or more items to be purchased, examples of which information may include, but should not be limited to, item identification information, item family identification information, item discount amount, in one or more forms and/or types of currency, minimum and/or maximum item quantities subject to the item discount amount, beginning and/or expiration date of the item discount amount, and the like. The term “print media” is defined for purposes of this disclosure as any tangible medium in which graphical and/or textual information, and/or any copy thereof, in whole or in part, is fixed and viewable by humans, with and/or without the aid of vision correction and/or vision enhancement. Some examples of print media may be or include, but should not be limited to, media that disseminates printed matter, such as, but not limited to, newspapers, newsletters, booklets, pamphlets, magazines, trade publications, directories, printed event programs and/or other printed publications, and any copies thereof, in whole or in part, electronic display devices displaying graphical and/or textual information for human viewing, such as, but not limited to, display screens of fixed, desktop and portable computing devices, such as fixed-installation, desktop, personal, lap top and notebook computers, display screens of thin, lean, slim, ultra-thin and/or web-thin client computers, display screens in one or more cloud computing systems, display screens of mobile computing devices such as smart phones, personal data assistants or the like, and any copies, in whole or in part, of any such graphical and/or textual information displayed on such an electronic display device, or the like. The term “print media coupon” is defined for purposes of this disclosure as any discount coupon that is part of, integral with, attached to or otherwise provided with any print media, as the term “print media” is defined above, and/or any virtual coupon, as the term “virtual coupon” is described above, that subsequently is, becomes part of, is or becomes integral with, is or becomes attached to, or is otherwise provided with, print media. The term “virtual print media coupon” is defined for purposes of this disclosure as any print media coupon, as this term is defined above, that has been converted to a virtual coupon as this term is defined above.

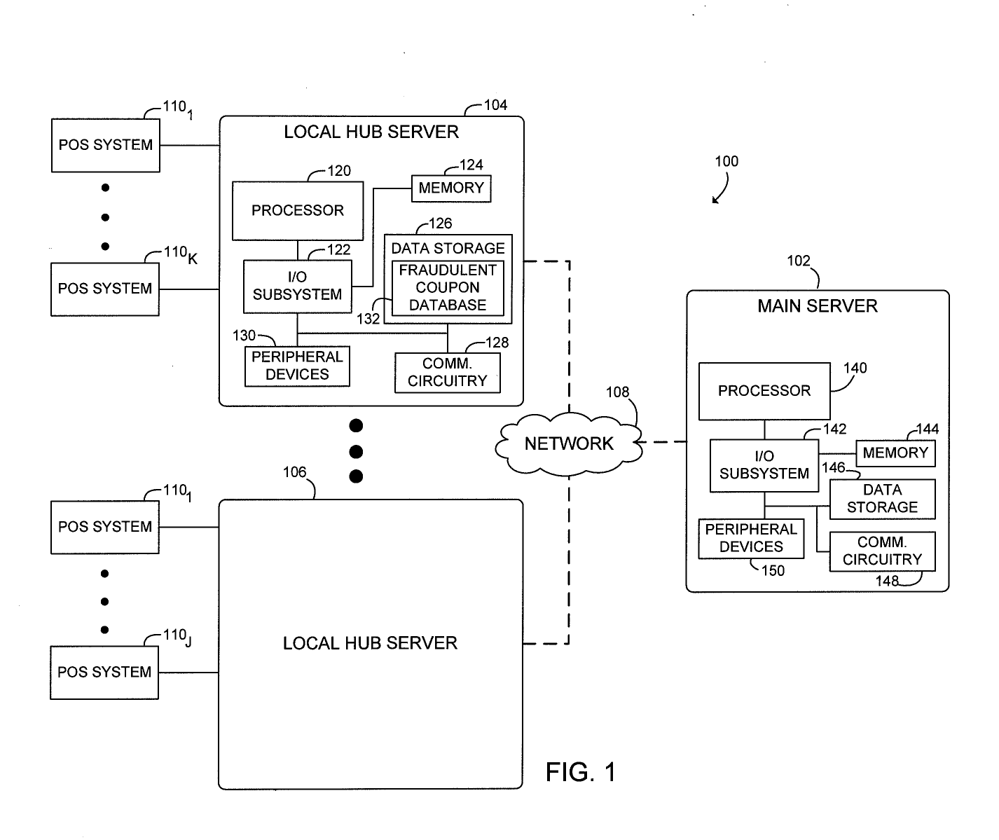

Referring now to FIG. 1, an embodiment of a system 100 is shown in which customers at a retail enterprise can generally redeem print media coupons, virtual coupons and/or virtual print media coupons. In the illustrated embodiment, the system 100 includes a main server 102 and, as discussed in more detail below, the main server 102 is configured to periodically acquire fraudulent coupon information from an external source, e.g., a third-party fraudulent coupon information service and to process the fraudulent coupon information to generate a fraudulent coupon data file which contains information identifying a plurality of discount coupons, which may be presented by customers to a retail establishment, as fraudulent, e.g., false, fake, forged, spurious, phony or counterfeit. During subsequent operation of the retail establishment, discount coupons presented by customers to the retail establishment are compared to the fraudulent coupon data file to determine whether any such presented discount coupons match one or more fraudulent coupons in the fraudulent coupon data file. Matching ones of the presented discount coupons are rejected, and the corresponding discount amounts of the matching presented discount coupons thus are not deducted from the corresponding items purchased by the customer.

Fraudulent discount coupons may exist in several different forms. For example, print media coupons, as this term is defined hereinabove, may be originally formed to be fraudulent and/or originally non-fraudulent coupons may be altered such that they then become fraudulent. As another example, fraudulent print media coupons may be processed to become fraudulent virtual print media coupons, as this term is described hereinabove, and thereafter presented to a retail establishment in virtual print media form. As yet another example, virtual coupons, as this term is defined hereinabove, may likewise be formed and/or altered to be fraudulent.

As will be described in detail below, fraudulent coupons may be presented to a purchase interface of a retail establishment in the form of a print media coupon, a virtual coupon and/or a virtual print media coupon. In cases where the purchase interface is a point-of-sale terminal at a brick-and-mortar location of the retail enterprise, for example, fraudulent coupons may be presented by customers in any of these three forms. In contrast, in cases where the purchase interface is a virtual point-of-sale environment, such as when accessing a web-based purchase interface or portal hosted by the retail enterprise, fraudulent coupons may typically be presented in the form of a virtual coupon and/or a virtual print media coupon.

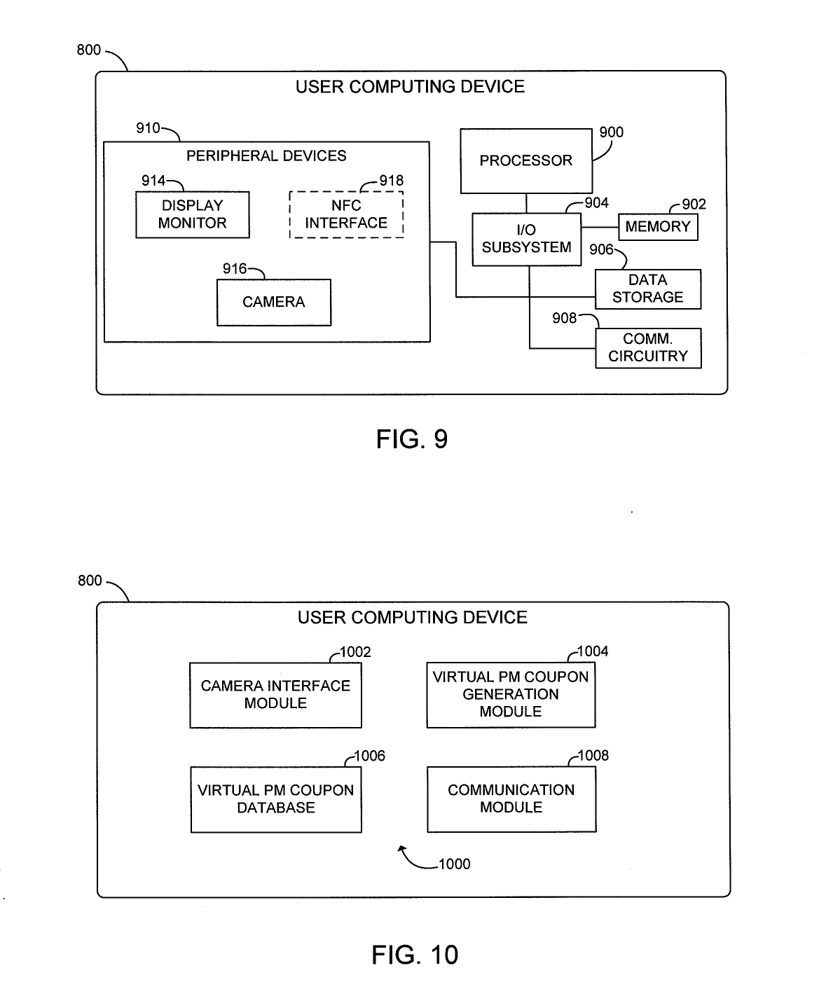

For purposes of clarity of the following description, FIGS. 1-7 will first be described in the context of processing strictly print media coupons presented by customers to purchase interfaces in the form of point-of-sale terminals at one or more brick-and-mortar locations of a retail establishment to determine whether any such presented print media coupons are fraudulent. With the aid of FIG. 8, these concepts will then be extended to processing virtual coupons and/or virtual print media coupons presented by customers to purchase interfaces in the form of such point-of-sale terminals and/or of virtual point-of-sale environments, e.g., on-line purchases via the Internet. Thereafter, FIGS. 9-15 will describe techniques for processing virtual coupons and/or virtual print media coupons, stored for subsequent redemption by a customer in a coupon repository managed by the retail enterprise, to determine whether any such virtual coupons and/or virtual print media coupons are fraudulent before being presented for redemption.

Referring again to FIG. 1, the main server 102 is coupled via a network 108 to a plurality of local hub servers 104, 106 each coupled to one or more conventional point-of-sale systems 110₁-110_{K}, 110₁-110_{J}, and each of the point-of-sale systems 110₁-110_{K}, 110₁-110_{J} is configured to process items selected by customers for purchase and to process payment for such items. Some retail enterprises may include a single brick and mortar outlet, and other larger enterprises may include two or more physically remote brick and mortar outlets. In the latter case, the retail enterprise may include, for example, a main physical location with two or more remote physical locations, and for purposes of this document the two or remote physical locations in such an arrangement are referred to as “hub” locations. In this disclosure, the system 100 will be illustrated and described in the context of such a larger retail enterprise having a main physical location and two or more physical hub locations. In this regard, the main server 102 in the system 100 shown in FIG. 1 will typically be located at a main business location of the retail enterprise, and will be coupled via the network 108 to two or more local hub servers 104, 106, each of which will typically be located at a different one of the two or more hub locations.

Each hub location may include any number of point-of-sale systems coupled to a corresponding local hub server, and in the embodiment illustrated in FIG. 1, for example, the local hub server 104 is communicatively coupled to “K” such point-of-sale systems 110₁-110_{K}, 110₁-110_{J} where K may be any positive integer, and the local hub server 106 is communicatively coupled to “J” such point-of-sale systems 110₁-110_{J}, where J may be any positive integer and where J may or may not be equal to K. Communicative coupling between the local hub server 104 and the one or more point-of-sale systems 110₁-110_{K}, and between the local hub server 106 and the one or more point-of-sale systems 110₁-110_{J}, may be accomplished using any known communication coupling, and communications over any such hardwire and/or wireless coupling may be accomplished using any known communication protocol.

In some alternative embodiments of such a large retail enterprise, one or more of the local hub servers 104, 106 may be omitted, and the main server 102 may be coupled directly, via the network 108, to the one or more point-of-sale systems 110₁-110_{K}, 110₁-110_{J}, or the main server may be omitted and at least one of the local hub servers 104, 106 may be configured to act as a so-called master server with the remaining local hub servers 104, 106 configured to act as so-called slave servers. In other alternative embodiments in which the retail enterprise includes only a single brick and mortar outlet, the local hub server 104, 106 may be or include the main server 102 or vice versa. For purposes of the following description, any process disclosed as being controlled by the main server 102 may, in some embodiments, instead be controlled, in whole or in part, by one or more local hub servers 104, 106 and vice versa, and/or may be controlled, in whole or in part, by one of the point-of-sale systems 110₁-110_{K}, 110₁-110_{J} and vice versa.

The local hub server 104 may be embodied as any type of server (e.g., a web server) or similar computing device capable of performing the functions described herein. In the illustrative embodiment of FIG. 1, the local hub server 104 includes a processor 120, an I/O subsystem 122, a memory 124, a data storage 126, a communication circuitry 128, and one or more peripheral devices 130. It should be appreciated that the local hub server 104 may include other components, sub-components, and devices commonly found in a sever and/or computing device, which are not illustrated in FIG. 1 for clarity of the description.

The processor 120 of the local hub server 104 may be embodied as any type of processor capable of executing software/firmware, such as a microprocessor, digital signal processor, microcontroller, or the like. The processor 120 may be a single processor or include multiple processors. The I/O subsystem 122 of the local hub server 104 may be embodied as circuitry and/or components to facilitate input/output operations with the processor 120 and/or other components of the local hub server 104. The processor 120 is communicatively coupled to the I/O subsystem 122.

The memory 124 of the user local hub server 104 may be embodied as or otherwise include one or more conventional volatile and/or non-volatile memory devices. The memory 124 is communicatively coupled to the I/O subsystem 122 via a number of signal paths. Although only a single memory device 124 is illustrated in FIG. 1, the local hub server 104 may include additional memory devices in other embodiments. Various data and software may be stored in the memory 124. The data storage 126 is also communicatively coupled to the I/O subsystem 122 via a number of signal paths, and may be embodied as any type of device or devices configured for the short-term or long-term storage of data such as, for example, memory devices and circuits, memory cards, hard disk drives, solid-state drives, or other data storage devices. In the illustrated embodiment, the data storage 126 includes a fraudulent coupon database 132 in which the fraudulent coupon data files, containing fraudulent coupon data corresponding to one or more fraudulent coupons, described above are stored. Alternatively or additionally, the fraudulent coupon database 132 may reside, in whole or in part, in the memory unit 124.

The communication circuitry 130 of the local hub server 104 may include any number of devices and circuitry for enabling communications between the local hub sever 104 and the main server 102 and between the local hub server 104 and the one or more point-of-sale systems 110₁-110_{K}. In the illustrated embodiment, for example, communication between the local hub server 104 and the main server 102 takes place wirelessly via the network 108, wherein the network 108 may represent, for example, a private or non-private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the local hub server 104 and the main server 102 may be, in whole or in part, a wired connection. Generally, the communication circuitry 130 may be configured to use any one or more, or combination, of conventional secure and/or unsecure communication protocols to communicate with the main server 102. As such, the network 108 may include any number of additional devices, such as additional computers, routers, and switches, to facilitate communications between the local hub server 104 and the main server 102. As discussed hereinabove, communication between the local hub server 104 and the one or more point-of-sale systems 110₁-110_{K}, 110₁-110_{J} may take place via one or more conventional wired or wireless communication interfaces.

In some embodiments, the local hub server 104 may also include one or more peripheral devices 132. Such peripheral devices 132 may include any number of additional input/output devices, interface devices, and/or other peripheral devices. For example, the peripheral devices 132 may include a display, a keyboard, a mouse, audio processing circuitry, and/or other input/output devices.

The local hub server 106 may be substantially similar to the local hub server 104 and include similar components, which have been identified in FIG. 1 with common reference numbers. As such, the description provided above of the components of the local hub server 104 may be equally applicable to those similar components of the local hub server 106 and are not repeated herein so as not to obscure the present disclosure. Of course, it should be appreciated that in some embodiments the local hub server 104, 106 may be dissimilar to each other.

An embodiment of the main server 102 is also illustrated in FIG. 1, and generally includes the same components as the local hub server 104. For example, a processor 140 is coupled to an I/O subsystem 142, and the I/O subsystem 142 is coupled to a memory 144, a data storage unit 146, communication circuitry 148 and one or more peripheral devices 150. In some embodiments, each of the foregoing components may be identical to corresponding components of the local hub server 104 described above, and a detailed explanation of such components will not be repeated here for brevity. In other embodiments, the main server 102 may be configured differently than the local hub server 104 described above. In any case, the communication circuitry 128 of each of the local hub servers 104, 106 facilitates communication with the communication circuitry 148 of the main server 102 and vice versa so that information can be shared between the main server 102 and each of the one or more local hub servers 104, 106 via the network 108. Although only one such main server 102 is shown in FIG. 1, it should be appreciated that, in other embodiments, the system 100 may include any number of main servers. In any case, the main server 102 may be embodied as any type of server (e.g., a web server) or similar computing device capable of performing the functions described herein.

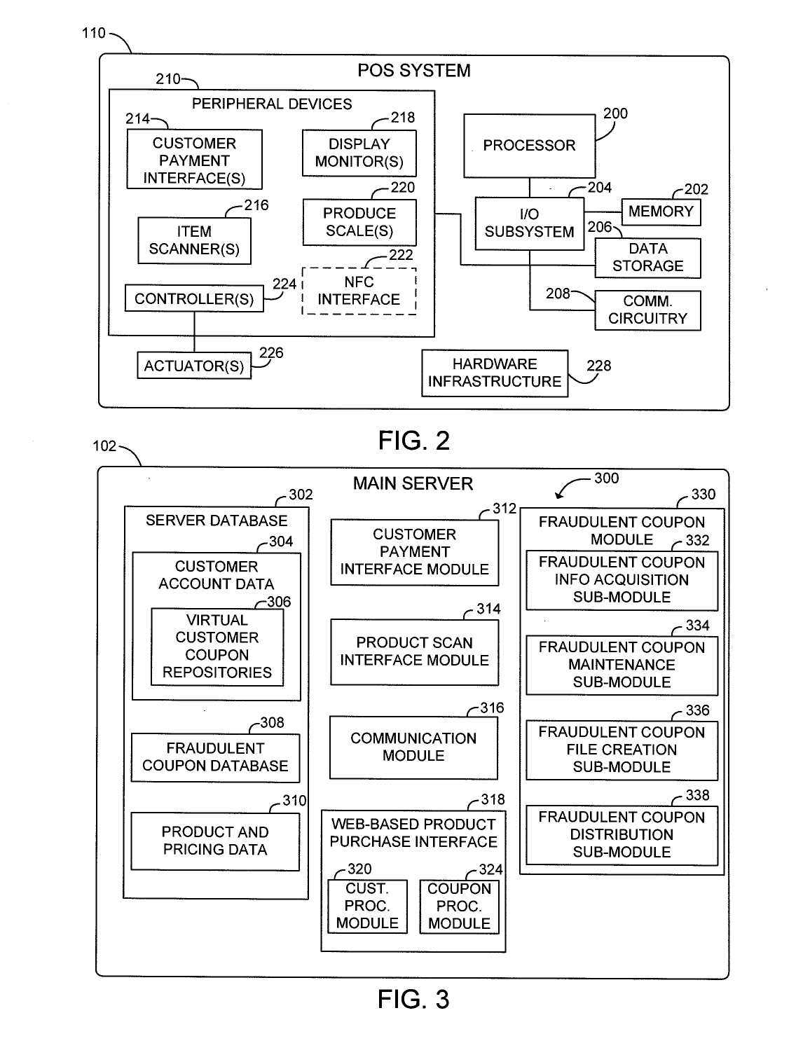

Referring now to FIG. 2, an embodiment 110 of one of the one or more point-of-sale systems 110₁-110_{K}, 110₁-110_{J}, is shown which includes components similar to the main server 102 and also to the one or more local hub servers 104, 106, such as a processor 200, an I/O subsystem 204, a memory 202, a data storage device 206, communication circuitry 208 and a number of peripheral devices 210. In some embodiments, each of the foregoing components may be identical to corresponding components of the local hub server 104 described above, and a detailed explanation of such components will not be repeated here for brevity. In other embodiments, any of the one or more point-of-sale systems 110₁-110_{K}, 110₁-110_{J} may be configured differently than the local hub server 104 described above. Additionally, the illustrated point-of-sale system 110 includes one or more actuators 226 and hardware infrastructure 228, examples of which will be described below. It will be appreciated that the point-of-sale system 110 may include other components, sub-components, and devices commonly found in a computer and/or computing device. In any case, the communication circuitry 208 is configured to facilitate communication with a corresponding one of the local hub servers 104, 106 and the point-of-sale system 110 may use any suitable communication protocol to communicate with the corresponding local hub server 104, 106.

In addition to, or alternatively to, the number of peripheral devices 130 of the local hub server 104 described above, the number of peripheral devices 210 of the point-of-sale system 110 may include any number of other peripheral or interface devices. Examples of some of the peripheral devices 210 illustrated in FIG. 2 include, but should not be limited to, one or more conventional customer payment interfaces 214, one or more conventional item price scanners 216, one or more conventional display monitors 218, one or more conventional produce scales 220 and one or more conventional controllers 224 for controlling one or more conventional actuators 226 associated with the operation of the point-of-sale system 110. The one or more customer payment interfaces 214 are provided, e.g., to facilitate receipt of credit/debit card and/or other form of payment from customers, and each such interface 214 may illustratively include one or more of a display, a touch screen, a keyboard, a mouse, external speakers, and/or other peripheral devices. One or more of the one or more customer payment interfaces 214 may further include a produce scale 220, and one or more produce scales 220 may alternatively be coupled to the point-of-sale system 110 separately from the one or more customer payment interfaces 214. The one or more item scanner(s) 216 is/are configured to scan price code labels or other such indicators for items being purchased by customers and to also scan print media coupons.

The one or more display monitor(s) 218 provide item and/or pricing information to customers and/or enterprise employees, and may further provide additional information regarding cost and/or discounts for one or more items being purchased as well as information regarding discounts realized by customers through the use of print media and/or virtual coupons. The peripheral devices 212 of the point-of-sale system 110 may further optionally include a near-field communication device 222, as illustrated in dashed-line configuration in FIG. 2, which may be included in embodiments in which one or more of handheld customer devices also has such a near-field communication device such that customer information, e.g., customer identification information in the form of one or more identification codes, user names, passwords, or the like, can be transferred from such one or more of the user computing devices 112₁-112_{M} to the point-of-sale system 110 by tapping the two near-field communication devices together or by passing the near-field communication device of a so-equipped user computing device 112₁-112ₘ sufficiently close to the near-field communication device 222 to effectuate such communication. In other embodiments, customers can transfer customer identification information to the point-of-sale system 110 via the customer payment interface 214, item scanner 216 or other peripheral device.

The point-of-sale system 110 further includes hardware infrastructure 228 which forms the structural backbone of the point-of-sale system 110. Examples of structural components that may be included in the hardware infrastructure 228 include, but should not be limited to, one or more purchased item transport units, e.g., one or more purchased item conveyance units or systems, one or more conventional purchased item bagging areas, e.g., one or more conventional item bagging carousals, one or more purchased item support units, and the like. The one or more actuators 226 may be or include any actuator is controllable by at least one of the one or more conventional controllers 224, and which may facilitate operation and/or control of the hardware infrastructure of the point-of-sale system 110. Examples of such one or more actuators may include, but should not be limited to, one or more linear and/or rotational drive motors, one or more electronically controlled switches, and the like.

Referring now to FIG. 3, a simplified block diagram is shown of an embodiment of an environment 300 of the main server 102 illustrated in FIG. 1. In the illustrated embodiment, the environment 300 includes a server database 302 which includes customer account data 304, a virtual customer coupon database 306, as will be described in greater detail below. The server database 302 further includes a fraudulent coupon database 308 in which received fraudulent coupon information is stored, and which fraudulent coupon data files, containing fraudulent coupon data corresponding to one or more fraudulent coupons, are stored, and product and pricing data 310 containing data relating to the products (and/or services) sold by the business enterprise, including pricing data. Illustratively, the product pricing information is linked to product identification information via scan codes such that when items are scanned for purchase, the scan code of each item will identify a particular item at a particular price in the product and pricing database 310.

The environment 300 of the main server 102 further includes a customer payment interface module 312, a product scan interface module 314, a communication module 316 and a virtual point-of-sale environment in the form of a web-based product purchase interface 318. The customer payment interface module 312 is configured, in a conventional manner, to process electronic forms of customer payment, e.g., credit card, debit card, etc., used at the point-of-sale systems 110₁-110_{K}, 110₁-110_{J}. The product scan interface module 314 is configured, in a conventional manner, to link item scanning activity at the point-of-sale systems 110₁-110_{K}, 110₁-110_{J} to the product and pricing database 310 so that the point-of-sale systems 110₁-110_{K}, 110₁-110_{J} have accesses to current item identity and pricing information for items being purchased. The communication module 316 is configured, in a conventional manner, to control and manage all communications between the main server 102 and the local hub servers 104, 106 in embodiments that include the local hub servers 104, 106, and to control and manage all communications between the main server 102 and all point-of-sale systems 110 in embodiments that do not include a local hub server 104, 106.

The web-based product purchase interface 318 includes a customer processing module 320, configured in a conventional manner, to process the sale of items via a web-based store or catalog (i.e., Internet-accessible web-site hosted by the business enterprise) by allowing customers to select items for purchase and by processing electronic forms of customer payment. The web-based product purchase interface 318 further includes a coupon processing module configured to process, in a conventional manner, a virtual coupon submitted by the customer by discounting the price of an item to be purchased by the discount amount of the virtual coupon.

The customer payment interface 214 and item scanner 216 of the point-of-sale system 110, together with the customer payment interface module 312 and product scan interface module 314 of the main server 102, make up one type of customer accessible product purchase interface in the form of a point-of-sale terminal physically located at a brick-and-mortar location of the business enterprise. The web-based product purchase interface 318 makes up another type of customer accessible product purchase interface in the form of a virtual point-of-sale environment that is accessible by customers via the Internet. In any case, the communication module 318 is configured, in a conventional manner, to control and manage all communications between the main server 102 and the local hub servers 104, 106.

The environment 300 of the main server 102 further includes a fraudulent coupon module 330 including a fraudulent coupon information acquisition sub-module 332, a fraudulent coupon maintenance sub-module 334, a fraudulent coupon file creation sub-module 336 and a fraudulent coupon distribution sub-module 338. The fraudulent coupon information acquisition sub-module 332 is configured to periodically acquire fraudulent coupon information, e.g., from a third-party source of fraudulent coupon information, and store the acquired fraudulent coupon information in the fraudulent coupon database 308. The fraudulent coupon maintenance sub-module 334 is configured to allow viewing, editing, deletion of and additions to the stored acquired fraudulent coupon information, to filter and/or search the information by, for example, manufacturer, brand, GS1 code, NSC5 code, expiration date and/or date added, and to allow for manual marking of the fraudulent coupon information as approved or unapproved. The fraudulent coupon file creation sub-module 336 is configured to create from the acquired fraudulent coupon information a fraudulent coupon file of fraudulent coupon data corresponding to one or more fraudulent coupons.

In one embodiment, the fraudulent coupon file creation sub-module 336 is configured to read the fraudulent coupon information from the acquired fraudulent coupon information stored in the database 308 and create a fraudulent coupon file in conventional comma separated values (CSV) format, although other conventional formats may alternatively be used. In any, case the fraudulent coupon file creation sub-module 336 further illustratively creates the fraudulent coupon file with an appropriate flag identifying approved coupons and another appropriate flag identifying unapproved and deleted coupons. One illustrative CSV form for a fraudulent coupon created from the acquired fraudulent coupon information is Flag, Brand, GS1, NSC5, Price, where Flag identifies the fraudulent coupon as either approved or unapproved/deleted, Brand identifies the maker of the product, GS1 is the conventional Global Standard One barcode format identifying the product, NSC 5 is the conventional Number System Character 5 barcode format identifying the product, and Price is the discount price of the coupon. It will be appreciated that other CSV forms may be used to create fraudulent coupons in the fraudulent coupon file, and/or that other conventional formats other than, or in combination with, CSV may be used to create the fraudulent coupons in the fraudulent coupon file. In any case, the created fraudulent coupon file is stored in the fraudulent coupon database 308 of the server database 302.

The fraudulent coupon distribution sub-module 338 is configured to send the created fraudulent coupon file to each of the item purchase processing locations of the business enterprise. In one embodiment, as illustrated in FIG. 1, the fraudulent coupon distribution sub-module 338 is configured to send the created fraudulent coupon file to each of the local hub servers 104, 106 for storage in the fraudulent coupon database 132, such that the one or more point-of-sale systems 110 associated with each local hub server 104, 106 can access the fraudulent coupon file directly from its associated local hub server 104, 106. In alternate embodiments, the fraudulent coupon distribution sub-module 338 may be configured to send the created fraudulent coupon file to each of the point-of-sale systems 110 for storage and direct use thereof. In other alternate embodiments, the fraudulent coupon distribution sub-module 338 may be omitted, and each of the various point-of-sale systems 110 may access the created fraudulent coupon file from the server database 302 via its local hub server 104, 106 in embodiments which include local hub servers 104, 106, or directly from the server database 302 in embodiments which do not include local hub servers 104, 106.

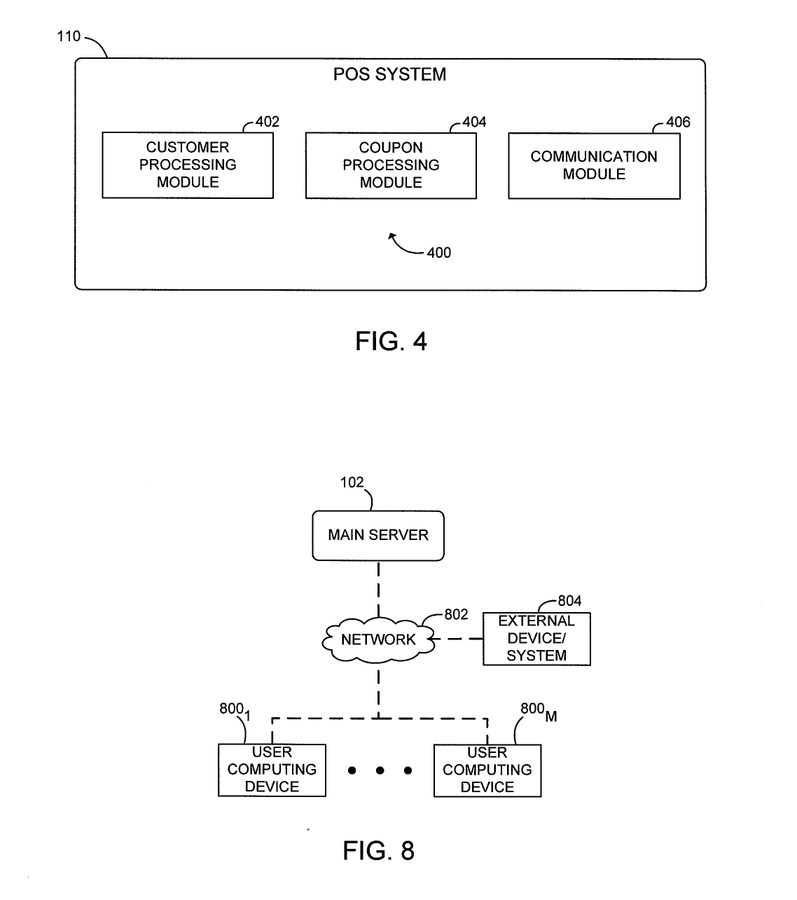

Referring now to FIG. 4, a simplified block diagram is shown of an embodiment of an environment 400 of one of the point-of-sale systems 110 illustrated in FIG. 1. In the illustrated embodiment, the environment 400 includes a customer processing module 402, a coupon processing module 404 and a communication module 406. The customer processing module 402 and the coupon processing module 404 are configured to communicate with the customer payment interface(s) 214 and the item scanner(s) 216 to control processing of items to be purchased and processing of coupons offered for redemption against items being purchased. The communication module 406 is configured, in a conventional manner, to control and manage all communications between the point-of-sale system 110 and its associated local hub server 104, 106 in embodiments that include the local hub servers 104, 106, and to control and manage all communications between the point-of-sale system 110 and the main server 102 in embodiments that do not include any local hub servers 104, 106.

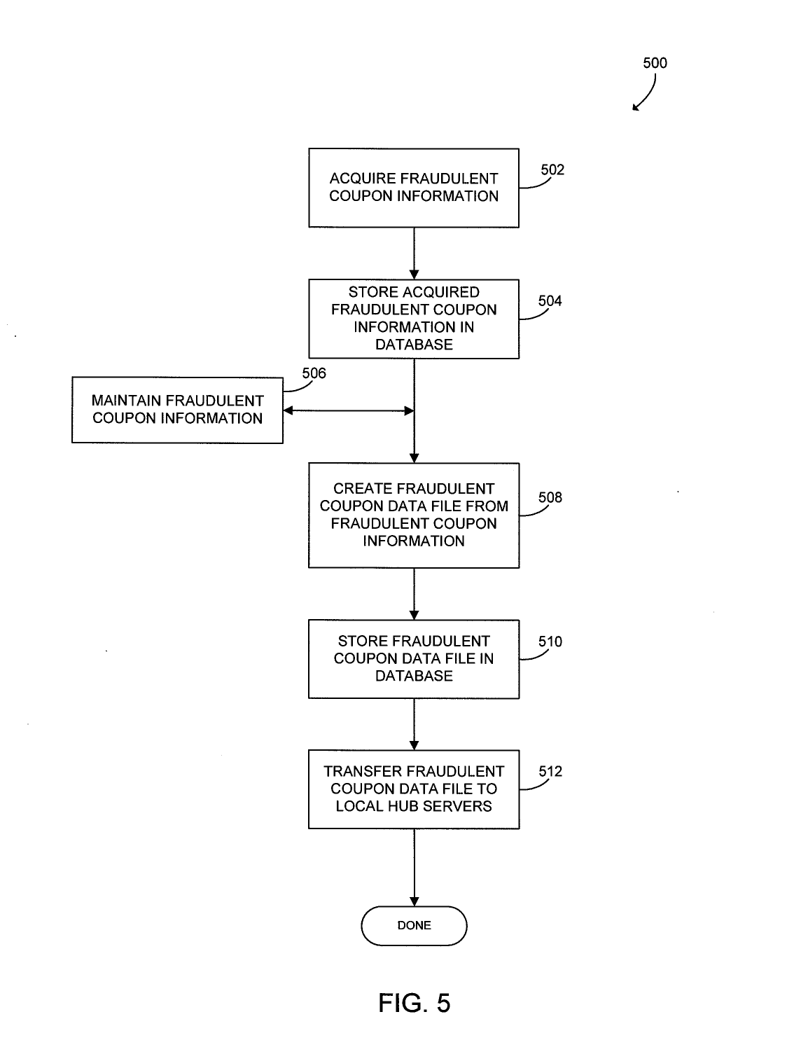

Referring now to FIG. 5, a simplified flow diagram is shown of an embodiment of a process 500 for acquiring and storing fraudulent coupon information, creating a fraudulent coupon data file from the acquired fraudulent coupon information and transferring the fraudulent coupon data file to the local hub servers 104, 106. In one embodiment, the process 500 is stored in the server memory 144 or data storage 146 in the form of one or more sets of instructions executable by the processor 140 according to the fraudulent coupon module 330 illustrated and described above. The process 500 begins at block 502 where the fraudulent coupon information acquisition sub-module 332 acquires the fraudulent coupon information from an external source. In one embodiment, for example, such fraudulent coupon information is obtained from Inmar, Inc. of Winston-Salem, N.C., although this disclosure contemplates that such fraudulent coupon information may, in other embodiments, be alternatively obtained from another third-party source or may alternatively still be created internally to the main server 102. In any case, step 502 is illustratively executed each time new or updated fraudulent coupon information is available, which may be periodic, e.g., once per day, every hour, continually, etc., or non-periodic, e.g., ad hoc.

The process 500 advances from step 502 where the processor 500 stores the acquired fraudulent coupon information in the fraudulent coupon database 308 of the server database 302. Thereafter at step 506, maintenance may be performed on the acquired fraudulent coupon information via the fraudulent coupon maintenance sub-module 334 as described above. The process 500 advances from step 506, or directly from step 504 in cases where no maintenance of the acquired fraudulent coupon information is performed, to step 508 where the fraudulent coupon file creation sub-module 336 processes the acquired fraudulent coupon information to create a fraudulent coupon data file according to a predefined file format as described above. Following step 508, the created fraudulent coupon data file is stored in the fraudulent coupon database 308 at step 510, and thereafter at step 512 the fraudulent coupon distribution sub-module 338 transfers the created fraudulent coupon data file to the various local hub servers 104, 106.

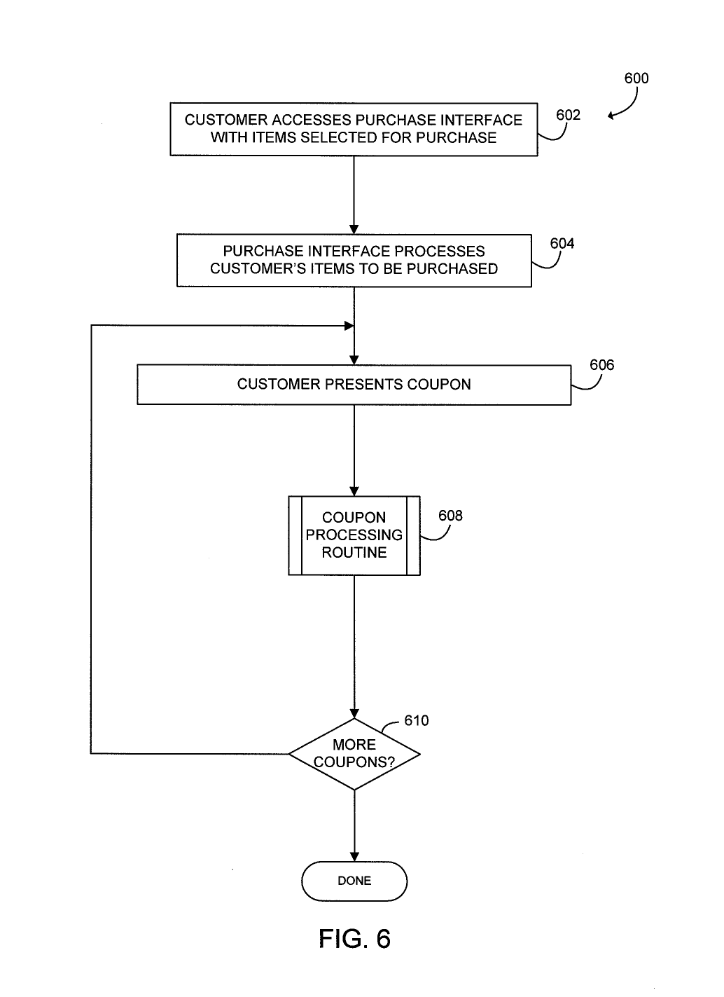

Referring now to FIG. 6, a simplified flow diagram is shown of an embodiment of a process 600 for processing coupons during a purchase transaction undertaken by a customer accessing a purchase interface of the business enterprise. For purposes of clarity, as indicated above, the process 600 will first be described in the context of processing strictly print media coupons, presented by customers during purchase transactions at purchase interfaces in the form of point-of-sale terminals 110 at one or more brick-and-mortar locations of a retail establishment, to determine whether any such presented print media coupons are fraudulent. In this regard, the process 600 is illustratively stored in the memory 202 or data storage 206 of the point-of-sale systems 110 in the form of one or more sets of instructions executable by the processor 200. In alternative embodiments, some or all of the one or more sets of instructions may be stored in a memory and/or data storage of another device or system, such as corresponding ones of the local hub servers 104, 106. In such embodiments, some or all of the one or more sets of instructions may be executed by the processor 200 of the point-of-sale systems 110, and/or some or all of the one or more sets of instructions may be executed by the processor 120 of the local hub server 104, 106. For purposes of this disclosure, however, the process 600 will be described as being executed by the processor 200.

The process 600 begins at step 602 where the customer accesses a purchase interface with items selected for purchase. In the present context, the customer accesses one of the point-of-sale systems 110 at step 602 such that the customer payment interface 214 and item scanner 216 of the point-of-sale system 110, together with the customer payment interface module 312 and product scan interface module 314 of the main server 102, make up the customer accessible product purchase interface. Following step 602, the process 600 advances to step 604 where the purchase interface processes the customer's items to be purchased in a conventional manner. Prior to, during or after this process, the customer presents at least one print media coupon to the purchase interface at step 606, e.g., by presenting at least one print media coupon to a cashier or by self-scanning at least one print media coupon using one of the item scanners 216. In any case, the process 600 advances from step 606 to step 608 where the processor 200 of the point-of-sale system 110 executes the coupon processing routine.

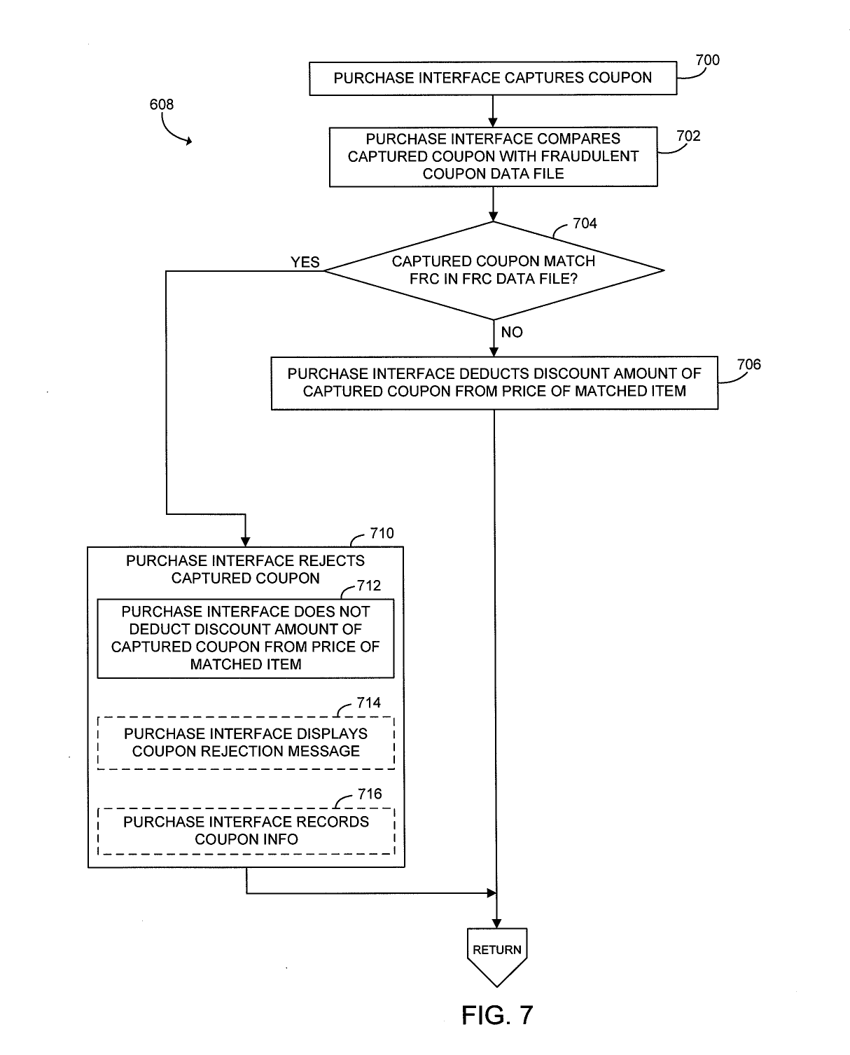

Referring now to FIG. 7, a simplified flow diagram is shown of an embodiment of the coupon processing routine of step 608 of the process 600 illustrated in FIG. 6. In the illustrated embodiment, the coupon processing routine 608 begins at step 700 where the processor 200 captures the printed media coupon, e.g., via scanning using an item scanner 216 of the point-of-sale system 110. Thereafter at step 702, the processor 200 compares the captured print media coupon with the fraudulent coupon data file stored in the data storage 126 of a corresponding local hub server 104, 106. In one embodiment, the processor 200 executes step 702 by first loading (or periodically pre-loading, e.g., as updated fraudulent coupon data files become available) the fraudulent coupon data file into the memory 202 or data storage 206 of the point-of-sale system 110, and then making the comparison. In alternative embodiments, the processor 200 may execute step 702 by sending the data associated with the captured print media coupon to the local hub server 104, 106, in which case the processor 120 of the local hub server 104, 106 makes the comparison. In any case, the coupon processing routine advances from step 702 to step 704 where the processor 200 of the point-of-sale system 110 determines whether the captured print media coupon matches a fraudulent coupon (FRC) in the fraudulent coupon (FRC) data file. If no match is found, then the captured print media coupon is not a fraudulent coupon and the coupon processing routine 608 advances to step 706 where the processor 200 of the point-of-sale system 110 deducts the discount amount of the captured print media coupon from the sale price of the matching item being purchased by the customer, and the coupon processing routine 608 then returns to the process 600 of FIG. 6. If, on the other hand, a match between the captured print media coupon and a fraudulent coupon in the fraudulent coupon data file is found at step 704, the coupon processing routine 608 advances to step 710.

In one embodiment, the processor 200 is configured to execute steps 702 and 704 by first determining whether some of the information associated with the captured print media coupon, i.e., whether the information in one or more of the data fields contained in the barcode of the captured print media coupon, matches that of one of the fraudulent coupons in the fraudulent coupon data file. Such information may include at least one of product brand information (Brand), GS1 information identifying the product and NSC 5 information identifying the product. In any case, if such information associated with the captured print media coupon matches that of a fraudulent coupon in the fraudulent coupon data file, the status flag of the fraudulent coupon is checked to determine whether it is an approved fraudulent coupon, or a deleted or unapproved fraudulent coupon. If the former, the processor 200 determines that the captured print media coupon is fraudulent and the process 600 follows the YES branch of step 704 and advances to step 710. If the processor 200 instead determines that the information associated with the captured print media coupon does not match that of a fraudulent coupon in the fraudulent coupon database, or if such information does match that of a fraudulent coupon in the fraudulent coupon database but the status flag of that fraudulent coupon is set to unapproved or deleted, the processor 200 determines that the captured print media is not fraudulent and the process 600 follows the NO branch to step 706.

In an alternate embodiment, the processor 200 is configured to execute steps 702 and 704 by comparing the information associated with the captured print media coupon, i.e., whether the information in one or more of the data fields contained in the barcode of the captured print media coupon, with that of only fraudulent coupons in the fraudulent coupon data file having a status flag set to Approved. Illustratively, this may be accomplished by first filtering the fraudulent coupons in the fraudulent coupon file to create a subset of fraudulent coupons having a status flag set to Approved, and the comparing the information associated with the captured print media coupon to only this subset of fraudulent coupons. Alternatively, this may be accomplished in real time by processing all of the fraudulent coupons in the fraudulent coupon file to first determine the state of the status flag of each fraudulent coupon, and then comparing the information associated with the captured print media coupon with that of the fraudulent coupon only for fraudulent coupons having a status flag set to Approved. Those skilled in the art will recognize other techniques for accomplishing step 702 and/or step 704 of the coupon processing routine 608 illustrated in FIG. 7, and it will be understood that such other techniques are contemplated by this disclosure.

At step 710, the processor 200 rejects the captured print media coupon. Illustratively, step 710 includes a sub-step 712 where the processor 200 rejects the captured print media coupon by not deducting the discount amount of the captured print media coupon from the sale price of the matching item being purchased by the customer. Step 710 may optionally include an additional step 714, as shown by a dashed-line block in FIG. 7, where the processor 200 controls one of the display monitors 218 and/or the customer payment interface to display a message indicating that the captured print media coupon has been rejected or was not accepted. Step 710 may alternatively or additionally further optionally include another additional step 716, as shown by a dashed-line block in FIG. 7, where the processor 200 records information about the captured print media coupon in the memory 202, which may then be transmitted back to a corresponding one of the local hub servers 104, 106 and/or to the main server 102. In any case, the coupon processing routine 608 returns after step 710 to the process 600 illustrated in FIG. 6. Referring once more to FIG. 6, the coupon processing routine 608 advances to step 610 where the processor 200 checks to determine whether any additional print media coupons are to be presented. If so, the process 600 loops back to step 606, and otherwise the process 600 terminates.

As described above, the fraudulent coupon processing techniques just described in the context of print media coupons processed by point-of-sale systems 110 at brick-and-mortar locations of the business enterprise are also applicable to virtual customer coupons that may likewise be processed at and by such point-of-sale systems 110. In this regard, the server database 302, in some embodiments, illustratively includes a portion which contains a plurality of virtual customer coupon repositories 306 (see FIG. 3) each configured to store and manage virtual coupons for a different one of a corresponding plurality of customers of the retail enterprise. In this regard, the main server 102 may be communicatively coupled at any one time to any number of user computing devices 800₁-800_{M} via a publicly accessible network 802 as illustrated in FIG. 8, and customers having access to such a virtual customer coupon repository may use one or more of the user computing devices 800₁-800_{M} to access and manage such repository via the network 114. The main server 102 in such embodiments is configured to selectively offer virtual coupons to any of the plurality of customers by selectively transferring one or more such virtual coupons from a virtual coupon database to any of the plurality of virtual customer coupon repositories 306. Such a dedicated virtual customer coupon repository may, in some embodiments, be available to customers who join a shopping club or similar service offered by the business enterprise in which customers provide the business enterprise with certain personal identification information and which the service typically then, in turn, provides discount offers for one or more items purchasable from the business enterprise, e.g., in the form of one or more corresponding virtual coupons. In such embodiments, customers may illustratively be issued a membership card or other such token which includes one or more identification codes unique to each such card or token (and therefore unique to each customer). Such one or more unique identification codes can be entered into any of the one or more point-of-sale systems 110₁-110_{K}, 110₁-110_{J}, e.g., by scanning a barcode or magnetic strip or other such identification code-carrying structure attached to or integral with the membership card or other such token and/or by manually or otherwise entering the one or more unique identification codes into a point-of-sale system 110₁-110_{K}, 110₁-110_{J}. When any such one or more unique identification codes is entered into a point-of-sale system 110₁-110_{K}, 110₁-110_{J}, the processor 200 of the point-of-sale system 110₁-110_{K}, 110₁-110_{J} identifies the customer and associates that customer with the current purchase transaction being carried out at the point-of-sale system 110₁-110_{K}, 110₁-110_{J}. The point-of-sale system 110₁-110_{K}, 110₁-110_{J}, which is communicatively coupled to the main server 102 via a local hub server 104, 106, can then access virtual coupons resident within that customer's virtual customer coupon repository 306 in the main server 102, and can automatically redeem each virtual coupon in the customer's virtual customer coupon repository that matches an item being purchased by the customer in a purchase transaction process 600. MPERKS®, a virtual customer coupon collection and redemption program offered to customers by Meijer, Inc. of Grand Rapids, Mich., is an example of one such shopping club or similar service, although it will be appreciated that any virtual customer coupon service which makes available to customers virtual customer coupon repositories in which virtual coupons can be stored and automatically redeemed by customers during item purchase transactions at point-of-sale systems or terminals may be alternatively be used.

While such virtual customer coupons offered by the retail enterprise to customers via their virtual customer coupon repositories 306 are unlikely, or perhaps less likely, to be fraudulent, the coupon processing routine 608 illustrated and described with respect to FIG. 7 may in any case be executed by the main server 102 at any time to screen or pre-screen any such virtual coupons offered to customers via the virtual customer coupon repositories 306.

The user computing devices 800₁-800_{M} used by customers to access their virtual customer coupon repositories 306 may be embodied as any type of computing device capable of performing the functions described herein, and any customer may use more than one type of user computing device 800₁-800_{M} to access their virtual customer coupon repositories 306. For example, any one or more of the user computing devices 800₁-800_{M} may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a network appliance, a web appliance, a distributed computing system, a multiprocessor system, a processor-based system, a consumer electronic device, a digital television device, a set top box, and/or any other computing device configured to store and access data, and/or to execute electronic game software and related applications.

Some such user computing devices 800₁-800_{M} may alternatively or additionally be used by one or more customers to convert print media coupons to virtual print media coupons, and to then add one or more such virtual print media coupons to their virtual customer coupon repository 306 for subsequent redemption at one of the point-of-sale systems 110 during a product purchase transaction. An example of one such computing device 800 is illustrated in FIG. 9 in which a simplified block diagram of an embodiment of one of the user computing devices 800 is shown. The user computing device 800 includes components similar to those of the main server 102 and also to the one or more local hub servers 104, 106, such as a processor 900, an I/O subsystem 904, a memory 902, a data storage device 906, communication circuitry 908 and a number of peripheral devices 910. In some embodiments, each of the foregoing components may be identical to corresponding components of the local hub server 104 described above, and a detailed explanation of such components will not be repeated here for brevity. The communication circuitry 908 is configured to facilitate communication with the main server 102 and/or with one or more other external devices and/or systems 804 (see FIG. 8) via the network 114 in a conventional manner, and the user computing device 800 may use any suitable communication protocol to communicate with the main server 102 and/or device(s)/system(s) 804. The peripheral devices 910 of the user computing device 800 illustrated in FIG. 9 include a conventional display monitor 914, a conventional camera 916 and, optionally, a near-field communication device 918 of the type described with respect to FIG. 2.

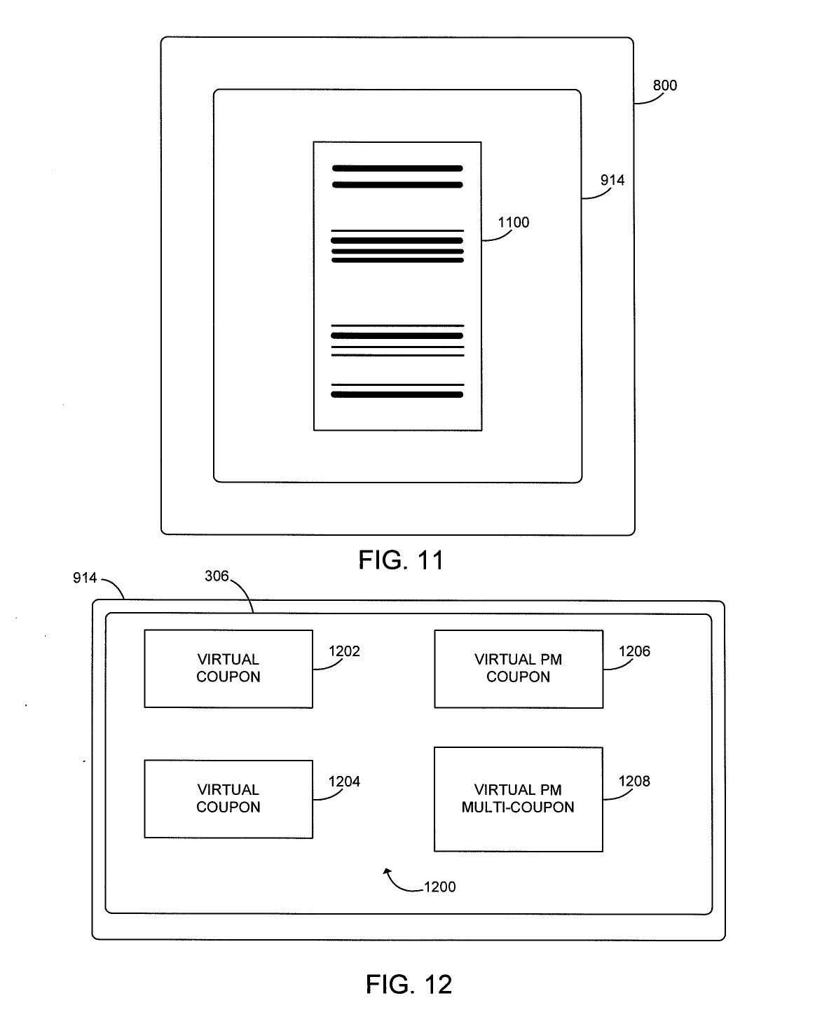

Referring now to FIG. 10, a simplified block diagram is shown of an embodiment of an environment 1000 of an example one 800 of any of the one or more user computing devices 800₁-800_{M} illustrated in FIG. 8. In the illustrated embodiment, the environment 1000 includes a camera interface module 1002, a virtual print media (PM) coupon generation module 1004, a virtual PM coupon database 5106 and a communication module 1008. The virtual PM coupon generation module 1004 is configured to selectively convert one or more forms of conventional print media coupons to virtual print media coupons by processing a photograph of the print media coupon, e.g., taken with the camera 916, and extracting the coupon information bar code 1100 of the print media as illustrated in FIG. 11. The thusly created virtual print media coupon may then be stored in the virtual print media coupon database 1006. The virtual print media coupon may be redeemed similarly to a print media coupon as described above with respect to FIG. 8 by using a handheld, e.g., mobile, user computing device 800 and displaying the coupon information barcode 1100 on the display 914 so that it may be scanned by an item scanner 216 of a point-of-sale system 110. Alternatively or additionally, the created virtual print media coupon may be transferred to and stored, along with other virtual coupons 1202, 1204 in the customer's virtual coupon repository 306 in the form of a single virtual print media coupon 1206 and/or as part of a virtual print media multi-coupon 1208 as illustrated in FIG. 12.

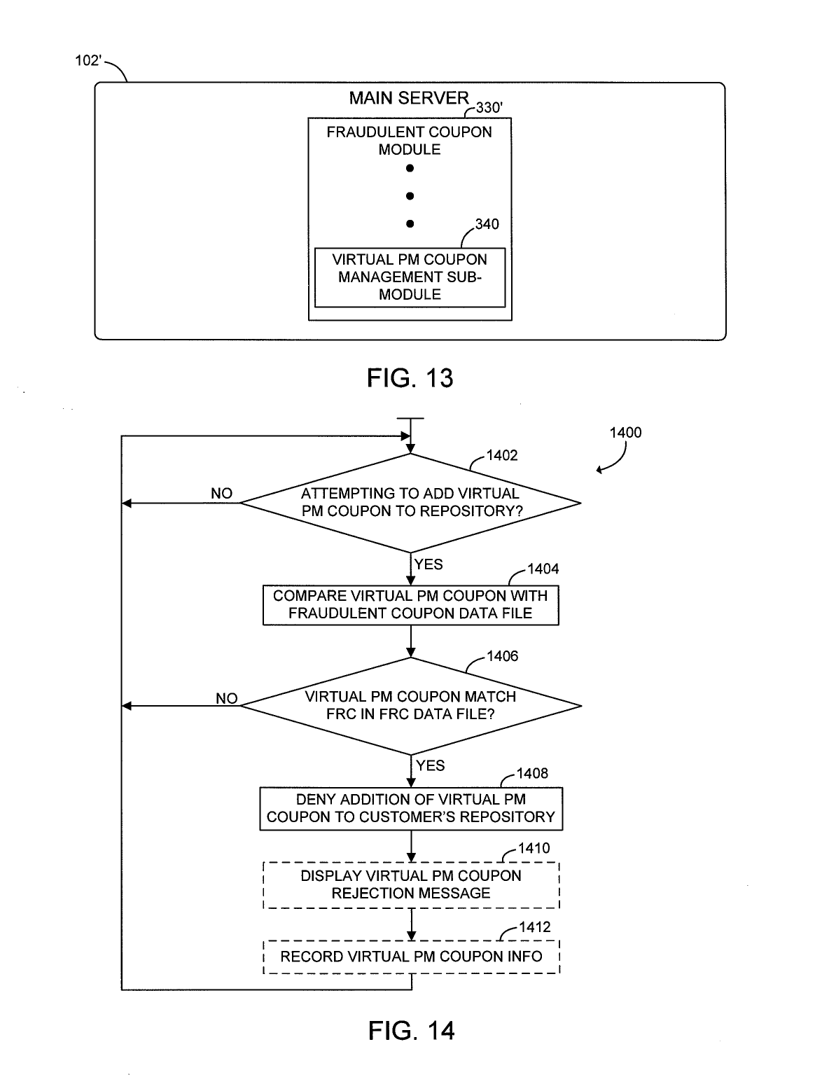

By allowing such virtual print media coupons to be stored in a customer's virtual coupon repository, this leaves open the possibility that one or more customers may intentionally or unintentionally create a fraudulent virtual print media coupon in the process of creating a virtual print media coupon if the print media coupon from which it is created is itself a fraudulent coupon. While on the one hand, the coupon processing routine 608 illustrated and described above can be used during the purchase transaction process 600 illustrated in FIG. 6 to detect and reject such fraudulent virtual print media coupons just as it does with print media coupons, it is also possible to screen or pre-screen virtual print media coupons prior to being offered for redemption so that fraudulent virtual print media coupons can be deleted or otherwise identified as non-redeemable before any attempted redemption during a purchase transaction. Referring to FIG. 13, for example, one embodiment of the fraudulent coupon module 330′ in an alternate embodiment 102′ of the main server may include a virtual print media coupon management sub-module 340 configured to screen virtual print media coupons transferred to a customer's virtual coupon repository 306, and/or to pre-screen virtual print media coupons being transferred to a customer's virtual coupon repository 306, for potentially fraudulent virtual print media coupons.

Referring now to FIG. 14, a simplified flow diagram is shown of an embodiment of a process 1400 for pre-screening virtual print media coupons being transferred to a customer's virtual coupon repository 306 for potentially fraudulent virtual print media coupons. In the illustrated embodiment, the process 1400 is illustratively stored in the server database 302 or other memory device(s) of the main server 102 in the form of one or more sets of instructions executable by the processor 140 of the server 102 continually, periodically or non-periodically. The process 1400 begins at step 1402 where the processor 200 determines whether a customer is adding a virtual print media coupon to that customer's virtual customer coupon repository 306, e.g., by determining whether the customer has stored one or more new virtual print media coupons to the customer's repository 306 since the process 1400 was last executed. If not, the process 1400 loops back to the beginning of step 1402, or alternatively waits until the next execution of the process 1400 in embodiments in which the process 1400 is not executed continually. If, at step 1402, the processor 200 determines that the customer is in the process of adding, or has added since the previous execution of the process 1400, a new virtual print media coupon to the customer's virtual customer coupon repository 306, the processor 200 compares the virtual print media coupon with fraudulent coupons in the fraudulent coupon data file at step 1404 and thereafter at step 1406 the processor 200 determines whether the virtual print media coupon matches any of the fraudulent coupons in the fraudulent coupon data file. Illustratively, the processor 200 may execute steps 1404 and 1406 according to any of the techniques described above with respect to steps 702 and 704 of the coupon processing routine 608.

If, at step 1406, the processor 200 determines that no match is found, then the virtual print media coupon is not a fraudulent coupon and the process 1400 loops back to step 1402, or alternatively waits until the next execution of the process 1400 in embodiments in which the process 1400 is not executed continually. If, on the other hand, a match between the virtual print media coupon and a fraudulent coupon in the fraudulent coupon data file is found at step 1406, the process 1400 advances to step 1408 where the processor 200 denies addition of the virtual print media coupon to the customer's virtual customer coupon repository 306, e.g., by disallowing storage of the virtual print media coupon in the repository 306, or by deleting the virtual print media coupon from the repository 306 or marking it as non-redeemable if the virtual print media coupon has already been added to the customer's virtual customer coupon repository 306. The process 1400 may optionally include an additional step 1410, as shown by a dashed-line block in FIG. 14, where the processor 200 controls a display monitor 914 of the user computing device 800 to display a message indicating that the virtual print media coupon has been rejected and/or was not added to the customer's virtual customer coupon repository 306. The process may alternatively or additionally further optionally include another additional step 1412, as shown by a dashed-line block in FIG. 14, where the processor 200 records information about the virtual print media coupon in the memory 144 or data storage 146 of the main server 102. In any case, the process 1400 loops from step 1408, 1410 or 1412 back to step 1402, or alternatively waits until the next execution of the process 1400 in embodiments in which the process 1400 is not executed continually.

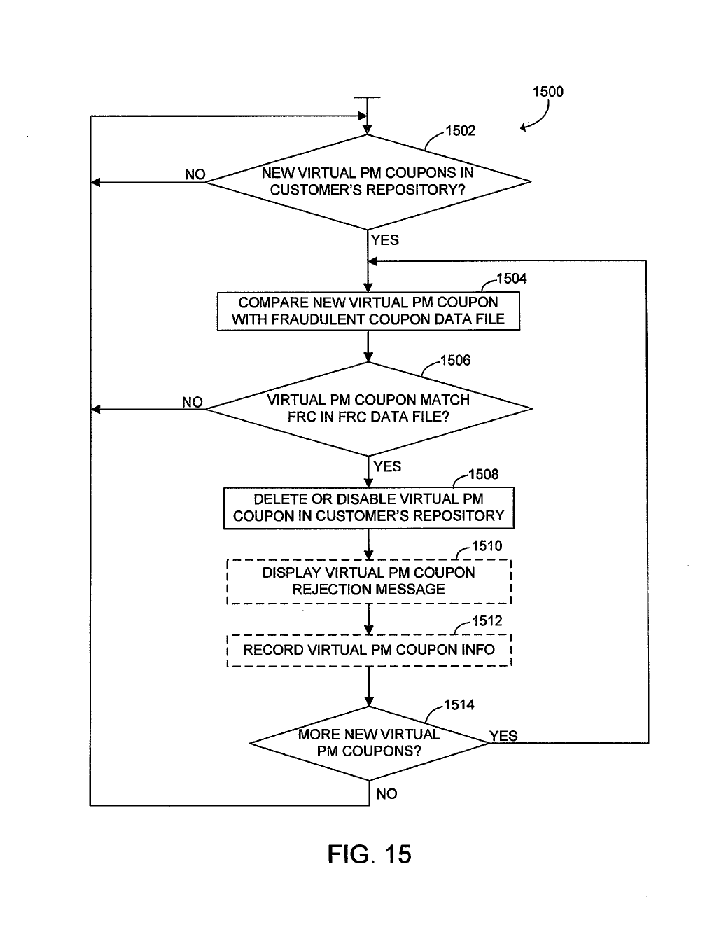

Referring now to FIG. 15, a simplified flow diagram is shown of an embodiment of a process 1500 for screening virtual print media coupons previously added to a customer's virtual coupon repository 306 for potentially fraudulent virtual print media coupons prior to being offered for redemption during a subsequent purchase transaction. In the illustrated embodiment, the process 1500 is illustratively stored in the server database 302 or other memory device(s) of the main server 102 in the form of one or more sets of instructions executable by the processor 140 of the server 102 continually, periodically or non-periodically. The process 1500 begins at step 1502 where the processor 200 determines whether a customer's virtual customer coupon repository 306 contains any new virtual print media coupons, e.g., by determining whether the customer has stored one or more new virtual print media coupons to the customer's repository 306 since the process 1500 was last executed. If not, the process 1500 loops back to the beginning of step 1502, or alternatively waits until the next execution of the process 1500 in embodiments in which the process 1500 is not executed continually. If, at step 1502, the processor 200 determines that the customer has added one or more new virtual print media coupons to the customer's virtual customer coupon repository since the previous execution of the process 1500, the processor 200 compares a first one of the virtual print media coupons with fraudulent coupons in the fraudulent coupon data file at step 1504 and thereafter at step 1506 the processor 200 determines whether the virtual print media coupon matches any of the fraudulent coupons in the fraudulent coupon data file. Illustratively, the processor 200 may execute steps 1504 and 1506 according to any of the techniques described above with respect to steps 702 and 704 of the coupon processing routine 608.

If, at step 1506, the processor 200 determines that no match is found, then the virtual print media coupon is not a fraudulent coupon and the process 1500 loops back to step 1502, or alternatively waits until the next execution of the process 1500 in embodiments in which the process 1500 is not executed continually. If, on the other hand, a match between the virtual print media coupon and a fraudulent coupon in the fraudulent coupon data file is found at step 1506, the process 1500 advances to step 1508 where the processor 200 deletes the virtual print media coupon from the repository 306 or disables the virtual print media coupon, e.g., by marking it as non-redeemable. The process 1500 may optionally include an additional step 1510, as shown by a dashed-line block in FIG. 15, where the processor 200 controls a display monitor 914 of the user computing device 800 to display a message indicating that the virtual print media coupon has been deleted from the customer's virtual customer coupon repository 306 or has been disabled and cannot be redeemed. The process 1500 may alternatively or additionally further optionally include another additional step 1512, as shown by a dashed-line block in FIG. 15, where the processor 200 records information about the virtual print media coupon in the memory 144 or data storage 146 of the main server 102. The process 1500 advances from step 1508, 1510 or 1512 to step 1514 where the processor 200 determines whether the customer's virtual customer coupon repository 306 contains any more new virtual print media coupons and, if so, the process loops back to step 1504 to process the next newly added virtual print media coupon in the repository 306. If, at step 1514, the processor 200 determines that the customer's virtual customer coupon repository 306 does not contain any more newly added virtual print media coupons, the process 1500 loops back to step 1502, or alternatively waits until the next execution of the process 1500 in embodiments in which the process 1500 is not executed continually.

Referring again to FIGS. 3 and 8, customers may in some embodiments conduct so-called on-line purchase transactions with the retail enterprise by accessing with a user computing device 800 the web-based product purchase interface 318 via the wireless communication network 802, e.g., the Internet, as an alternative or additionally to purchase transactions made using one of the point-of-sale systems 110. In such embodiments, customers may be permitted to redeem virtual coupons stored in the customer's virtual customer coupon repository 306 and/or stored in the memory 902 or data storage 906 of the user computing device 800. In the latter case, such virtual coupons may be virtual print media coupons created by the customer and stored in the memory 902 or data storage 906 as described above, and/or may be virtual coupons previously transferred to the memory 902 or data storage 906 from an external device or system 804 via the network 802. Examples of the one or more external devices and/or systems 804 may include, but should not be limited to, one or more servers and/or other computing device(s) hosting a web site which may be accessed in a conventional manner, a computer, a desktop computer, a personal computer (PC), a tablet computer, a laptop computer, a notebook computer, a mobile computing device, a smart phone, a cellular telephone, a handset, a messaging device, a work station, a network appliance, a web appliance, a distributed computing system, a multiprocessor system, a processor-based system, a consumer electronic device, a digital television device, a set top box, and/or any other computing device configured to store and access data. In any case, it is possible that any such virtual print media coupons and/or virtual coupons may be fraudulent.

Virtual coupons stored in the memory 902 or data storage 906 in the form of virtual coupons received from a third party source, i.e., from a source other than the retail enterprise served by the system 10 of FIG. 1, and/or in the form of virtual print media coupons created from conventional print media coupons as described by example herein, may be fraudulent. In one embodiment, either of the processes 1400 or 1500 may be used to pre-screen or screen such virtual coupons and/or virtual print media coupons added to a customer's virtual customer coupon repository 306 for fraudulent coupons as described above, and in such embodiments the virtual PM coupon management sub-module 340 illustrated in FIG. 13 may be used to process such virtual coupons and/or virtual print media coupons added to a customer's virtual customer coupon repository 306 according to the pre-screening process 1400 illustrated in FIG. 14 and/or according to the screening process 1500 illustrated in FIG. 15. Alternatively or additionally, the customer processing module 320 of the web-based product purchase interface 318 may include a purchase transaction process similar or identical to the process 600 illustrated in FIG. 6, and the coupon processing module 324 may include the coupon processing routine 608, such that fraudulent coupons in the form of virtual coupons and/or virtual print media coupons stored in the memory 903 or data storage 906 of the user computing device 800 are detected and rejected as described above with respect to FIGS. 6 and 7.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected.

What is claimed is:

1. A system for processing a coupon offered for redemption in relation to a purchase transaction, the system comprising:
a database having stored therein fraudulent coupon data corresponding to one or more fraudulent coupons, and
a purchase interface to process the purchase transaction, the purchase interface having a coupon processing module to compare the coupon to the fraudulent coupon data stored in the database and to automatically deduct a discount amount of the coupon from a price of a corresponding item included in the purchase transaction if the coupon does not match any of the one or more fraudulent coupons.

2. The system of claim 1 further wherein the purchase interface comprises a point-of-sale terminal communicatively coupled to the database.

3. The system of claim 1 further comprising a server coupled to the database,
wherein the purchase interface comprises a web-based product purchase interface hosted by the server.

4. The system of claim 1 wherein the coupon processing module to otherwise not deduct the discount amount of the coupon from the price of the corresponding item included in the purchase transaction if the coupon matches any of the one or more fraudulent coupons.

5. The system of claim 1 wherein the purchase interface comprises a memory,
and wherein the coupon processing module to record information about the coupon in the memory if the coupon matches any of the one or more fraudulent coupons.

6. The system of claim 4 wherein the purchase interface comprises a display,
and wherein the coupon processing module to control the display to display a message informing that the discount amount of the coupon was not deducted from the price of the corresponding item included in the purchase transaction if the coupon matches any of the one or more fraudulent coupons.

7. The system of claim 1 wherein the fraudulent coupon data includes a status flag for each fraudulent coupon stored in the database,
and wherein the coupon processing module to compare the coupon only to fraudulent coupons in the database having a status flag set to a predefined state.

8. The system of claim 1 wherein the fraudulent coupon data includes a status flag for each fraudulent coupon stored in the database,
and wherein the coupon processing module to reject the coupon as fraudulent and not deduct the discount amount of the coupon from the price of the corresponding item included in the purchase transaction if the coupon matches one of the fraudulent coupons in the database and the status flag of the one of the fraudulent coupons is set to a predefined state.

9. The system of claim 1 further comprising a fraudulent coupon module including a fraudulent coupon acquisition sub-module to acquire fraudulent coupon information from a source of fraudulent coupon information, a fraudulent coupon file creation sub-module to create the fraudulent coupon data from the fraudulent coupon information and to store the fraudulent coupon data file in the database.

10. The system of claim 9 wherein the fraudulent coupon file creation sub-module to create the fraudulent coupon data having a predefined format.

11. The system of claim 9 wherein the fraudulent coupon file creation sub-module to create the fraudulent coupon data to include for each fraudulent coupon a status flag, product identification information, and product discount information, the status flag having a first state indicating that the fraudulent coupon is an approved fraudulent coupon for use by the coupon processing module and a second state indicating that the fraudulent coupon is not an approved fraudulent coupon for use by the coupon processing module.

12. The system of claim 9 further comprising a first server communicatively coupled to a second server, and wherein the second server is communicatively coupled to the purchase interface, the first server having a first database and the second server having a second database,
and wherein the database in which the fraudulent coupon data file is stored is one of the first and second databases.

13. The system of claim 1 further comprising:
a virtual coupon repository having stored therein a virtual print media coupon created from a corresponding print media coupon, and
a virtual print media coupon processing module to compare the virtual print media coupon in the virtual coupon repository to the fraudulent coupon data stored in the database and to one of delete the virtual print media coupon from the virtual coupon repository and disable redemption of the virtual print media coupon if the virtual print media matches any of the one or more fraudulent coupons such that the created virtual print media coupon cannot be redeemed via the virtual coupon repository against an item included in the purchase transaction.

14. The system of claim 1 further comprising:
a virtual coupon repository,
a user computing device to create a virtual print media coupon from a corresponding print media coupon, and
a virtual print media coupon processing module to compare the created virtual print media coupon to the fraudulent coupon data stored in the database and to disallow storage of the created virtual print media coupon in the virtual coupon repository if the virtual print media matches any of the one or more fraudulent coupons such that the created virtual print media coupon cannot be redeemed via the virtual coupon repository against an item included in the purchase transaction.

15. A method for processing a coupon offered for redemption in relation to a purchase transaction, the method comprising:
comparing the coupon to fraudulent coupons stored in a fraudulent coupon database, and
automatically deducting a discount amount of the coupon from a price of a corresponding item included in the purchase transaction if the coupon does not match a fraudulent coupon in the fraudulent coupon database.

16. The method of claim 15 further comprising not deducting the discount amount of the coupon from the price of the corresponding item included in the purchase transaction if the coupon matches a fraudulent coupon in the fraudulent coupon database.

17. The method of claim 16 further comprising recording information about the coupon in a memory unit if the coupon matches a fraudulent coupon in the fraudulent coupon database.

18. The method of claim 16 further comprising control a display to display a message informing that the discount amount of the coupon was not deducted from the price of the corresponding item included in the purchase transaction if the coupon matches a fraudulent coupon in the fraudulent coupon database.

19. The method of claim 15 further comprising comparing a virtual print media coupon created from a print media coupon and stored in a virtual coupon repository to the fraudulent coupons stored in a fraudulent coupon database, and
one of deleting the virtual print media coupon from the virtual coupon repository and disabling redemption of the virtual print media coupon if the virtual print media matches a fraudulent coupon in the fraudulent coupon database such that the created virtual print media coupon cannot be redeemed via the virtual coupon repository against an item included in the purchase transaction.

20. The method of claim 15 further comprising comparing a virtual print media coupon created from a print media coupon to the fraudulent coupons stored in a fraudulent coupon database, and
disallowing storage of the created virtual print media coupon in a virtual coupon repository if the virtual print media matches a fraudulent coupon in the fraudulent coupon database such that the created virtual print media coupon cannot be redeemed via the virtual coupon repository against an item included in the purchase transaction.
